(19) United States
(12) Patent Application Publication
(10) Pub. No.: US 2010/0283757 A1
(43) Pub. Date: Nov. 11, 2010

(54) CAPACITIVE TOUCH PANEL STRUCTURE WITH HIGH OPTICAL UNIFORMITY

(75) Inventors: Kun-Long Wu, Tainan (TW); Yu-Wei Liu, Tainan (TW)

Correspondence Address: DITTHAVONG MORI & STEINER, P.C., 918 Prince Street, Alexandria, VA, 22314, US

(73) Assignee: Sintek Photronic Corporation, Sinshih Township (TW)

(21) Appl. No.: 12/768,024

(22) Filed: Apr. 27, 2010

(30) Foreign Application Priority Data
May 8, 2009 (TW) 098115429

(51) Int. Cl. G06F 3/045

(52) U.S. Cl. 345/174

(57) ABSTRACT

A capacitive touch panel structure with high optical uniformity includes a substrate, a metal layer, an insulating layer and an electrode layer. The metal layer is formed on surface of the substrate to constitute a plurality of metal bridge patterns and a plurality of traces. The insulating layer is coated on the surfaces of the substrate, and a plurality of via holes are formed on partial surface of the metal bridge patterns. A first direction electrode pattern, without electrically connected with the metal bridge patterns, is formed on the surface of the insulating layer between the metal bridge patterns. A second direction electrode pattern covers over the partial metal bridge patterns and into the via holes.

### BACKGROUND OF THE INVENTION

1. Field of the Invention

The present invention relates to a touch panel, and more particularly to a capacitive touch panel structure with high optical uniformity.

2. Description of the Prior Art

Touch panels can be produced in a variety of types and sizes without mouse, button or direction key and can be used as input part of a wide variety of electronic devices. With information appliance developing, the touch panels have replaced keyboard and mouse to communicate with the information appliance. The touch panels provide users a friendly interface such that operations of computers or electronic products become simple, straightforward, lively and interesting. Depending on fields of applications, touch panels are applied to portable communication and information products (for example, personal digital assistant (PDA)), financial/commercial system, medical registration system, monitoring system, information guiding system, and computer-aided teaching system, and thereby enhancing convenience of handling for users.

Generally speaking, touch panels may be operated by means of infrared, ultrasonic, piezoelectric, capacitive or resistive sensing. The capacitive touch panel has inner wires made of transparent conductive materials on a glass substrate, and transmitting signals to integrated circuits (IC) configured on an outer flexible PCB or rigid PCB via peripheral conductive wires on the glass substrate. Such structure constitutes a touch sensor, which configured to an outer printed circuit board and a top protecting cover to complete a touch panel. A uniform electric field is generated on surface of the glass substrate when touching. Coordinates of the contact point are determined by variation of capacitance due to electrostatic reaction generated between the user's finger and the electric field when an user touches the touch panel.

As illustrated in FIG. 5, for example, a conventional touch sensor structure is disclosed in the U.S. Pat. No. 7,084,933, and it discloses the touch panel used in a display panel which is a capacitive touch panel 400. The capacitive touch panel 400 includes an insulating substrate 30. Materials of the insulating substrate 30 could be glass, quartz, and diamond etc. The capacitive touch panel 400 further includes upper transparent electrodes 31 and lower transparent electrodes 31′ which can be arranged on upper surface and lower surface of the insulating substrate 30, respectively. Materials of the upper transparent electrodes 31 and the lower transparent electrodes 31′ may be a Indium-Tin-Oxide (ITO), Tin-Antimony-Oxide (TAO) or other transparent and conductive materials. Metal electrodes 32 can be arranged on corners and/or sides of the upper transparent electrode 31 to form a resistive network in the periphery of the upper transparent electrode 31. A passivation layer 33 is arranged over the entire surface of the insulating substrate 30 and directly on the metal electrodes 32 and the upper transparent electrode 31.

As the description above, the insulating substrate 30 of conventional capacitive touch panel 400 has relative large thickness. It could easily lead to an optical phase shift between the upper transparent electrodes 31 and the lower transparent electrodes 31′ which level differencing can be visualized by human eyes. When the electronic device is tilted by an angle, electrode patterns spacing of the upper and lower transparent electrodes could be visualized as unequal. In addition, although Indium-Tin-Oxide (ITO) is a conductive material, it still has higher sheet resistance than that of metal materials. As the size of the electronic devices increase, the affections of the environmental factors such as humidity or electrostatic become larger.

The present invention provides a novel touch panel structure to overcome the issues of low sensitivity and accuracy.

### SUMMARY OF THE INVENTION

In view of the above-mentioned issues, the present invention provides a capacitive touch panel structure with high optical uniformity.

In an aspect, the capacitive touch panel structure comprises a substrate, a metal layer, an insulating layer, and an electrode layer. The metal layer is formed on surface of the substrate to form a plurality of metal bridge patterns spaced apart in a predetermined distance within a visual area of the touch panel and to form a plurality of traces for transmitting signals from the electrode layer to outer integrated circuits outside of the visual area of the touch panel. The insulating layer is coated on the surfaces of the substrate, and a plurality of via holes is formed on partial surface of the metal bridge patterns. The electrode layer includes a first direction electrode pattern and a second direction electrode pattern. The first direction electrode pattern, which is not electrically connected (covered) with the metal bridge patterns, is formed on surface of the insulating layer between the metal bridge patterns. The second direction electrode pattern partially covers over the metal bridge patterns and into the via holes. Signals can be transmitted between the second direction electrode patterns through individual metal bridge patterns.

One advantage of the present invention provides users capacitive touch panels with clear outward appearance because of its high optical uniformity structure. Therefore, the electrode pattern can not be recognized by human eyes.

The other advantage of the present invention is to provide a capacitive touch panel structure with higher transmission and better reliability.

Another advantage of the present invention is to simplify the manufacturing processes and reduces the cost of the capacitive touch panels.

Yet another advantage of the present invention is to reduce the resistance by using metal bridge instead of conventional ITO bridge for improving the sensitivity. And the structure of the present invention further overcomes the discontinuity of electrode patterns at metal bridge pattern edges in the preferred embodiments.

### BRIEF DESCRIPTION OF THE DRAWINGS

FIG. 1 is a cross-sectional view of a capacitive touch panel structure.

FIG. 2 is a top view of a capacitive touch panel structure.

FIG. 3 is the cross-sectional view of the FIG. 2 through the B-B″ line cut.

FIG. 4a is a bottom view of the metal bridge pattern of a basal capacitive touch panel structure.

FIG. 4b is the cross-sectional view of the FIG. 4a through the A-A″ line cut.

FIG. 4c is the bottom view of the metal bridge pattern of an advanced capacitive touch panel structure.

FIG. 4d is the bottom view of the metal bridge pattern of another advanced capacitive touch panel structure.

FIG. 5 is the illustration of a conventional capacitive touch panel structure.

### DETAILED DESCRIPTION OF THE PREFERRED EMBODIMENT

The invention will now be described in greater detail with preferred embodiments and illustrations attached. Nevertheless, it should be recognized that the preferred embodiments of the invention are only for illustrating. Besides the preferred embodiments mentioned here, this present invention can be practiced in a wide range of other embodiments besides those explicitly described, and the scope of the present invention is expressly not limited expect as specified in the accompanying Claims.

For one of the touch panel structure in prior art, the insulating layer covers part of the metal bridge pattern, after a high temperature process, for example high temperature indium-tin-oxide (ITO) layer sputtering deposition, the edge of insulating pattern will contract and form a cavity between the insulating pattern and ITO layer. The situation will get worse in the island-like insulating patterns and will reduce yield and reliability. In the present invention, the insulating layer fully covers except two via holes located over the metal bridge patterns. In accordance with the via holes structure provided by the present invention, the drawback of the above-mentioned structure can be greatly improved. Further, in the above-mentioned touch panel structure, the island like insulating layer structure only partially covers the middle part of the metal bridge pattern, and therefore the two ends of the metal bridge pattern would expose to the following processes. In the present invention, the two ends of the metal bridge pattern is designed as cross shapes and the all ends of the cross shapes are covered by the side walls of the insulating layer, and therefore the all ends would not expose to the following processes. In addition, this arrangement can increase the contact area between the metal bridge pattern and the sub-sequentially formed the second direction electrode layer. The benefits of this arrangement are to reduce the integrated resistance of the bridge pattern section as well as to increase sensitivity of the touch panel device. Moreover, in the capacitive touch panel structure of the present invention, the insulating layer fully covers (forms on) the metal bridge pattern and the substrate to provide higher and more uniform transmission. By estimated, the transmission can be increased about 3%.

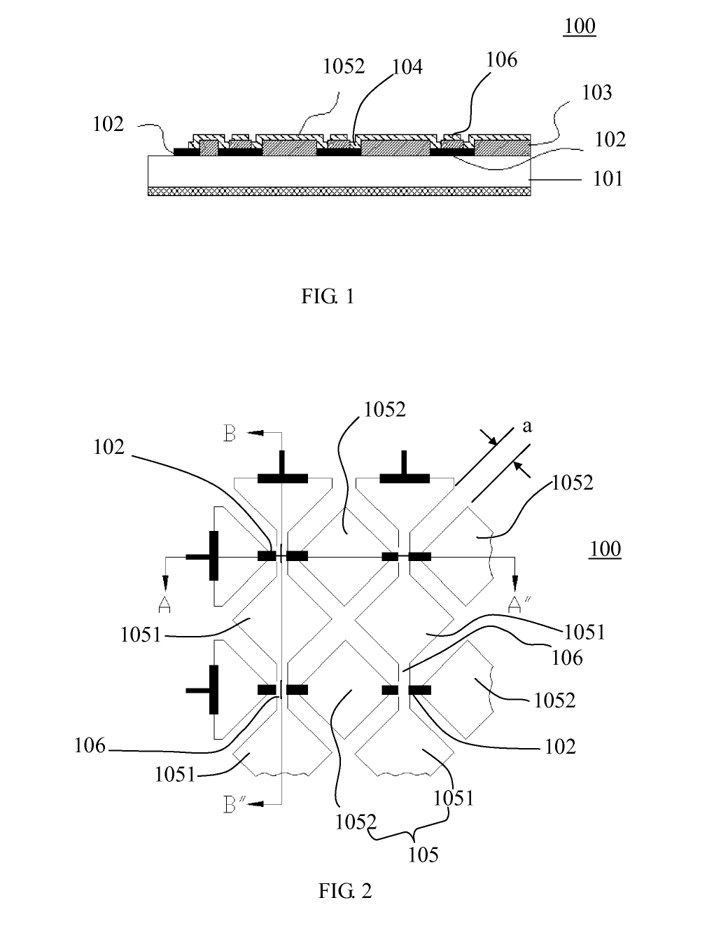

The capacitive touch panel structure disclosed by the present invention is illustrated in FIG. 1, which is the cross-sectional view of FIG. 2 along the A-A′ line cut. Referring to FIG. 1, the capacitive touch panel structure 100 includes a substrate 101, a metal bridge layer 102, an insulating layer 103, an electrode layer, and electrode bridge layer 106. In one aspect of the present invention, the substrate may be a glass substrate. The metal bridge pattern 102 is formed on one surface of the substrate 101 by utilizing a photolithography process and an etching process, and each of the individual patterns is spaced by a predetermined distance. The metal bridge pattern 102 may be formed by utilizing a first mask to perform the photolithography process and then performing the etching process, meanwhile, outer signal transmission lines and alignment marks can be formed. The insulating layer 103 is coated entirely on upper surface of the substrate 101 except the regions which are needed for electrical connections, filled up the regions between the metal bridge patterns 102, and part of top surfaces of the metal bridge patterns 102. In one aspect of the present invention, the insulating layer may be formed by a second mask to perform a photolithography process and an etching process, and the material of the insulating layer can be silicon dioxide (SiO₂). The insulating layer is thicker than the metal bridge patterns 102 for forming the plurality of via holes 104. The plurality of via holes 104 may be formed on edge of upper surface of the metal bridge patterns 102.

In one aspect of the present invention, the electrode layer 105 includes a first direction electrode, for example Y-axis electrode 1051, and a second direction electrode, for example X-axis electrode 1052. Referring to FIG. 2, each direction electrode layer comprises a plurality of electrode wires. In one aspect of the present invention, material of the electrode layer 105 may be Indium-Tin-Oxide. As illustrated in FIG. 1, the X-direction electrode layer 1052 for electrical connecting to the metal bridge patterns 102 is formed into the via holes 104 and upper surface of the insulating layer 103 located between the metal bridge patterns 102. An electrode bridge layer 106 for electrical connection the Y-axis electrode layer 1051 is formed on the insulating layer 103 on top of the metal bridge pattern 102. In one aspect of the present invention, the electrode layer 105 and the electrode bridge layer 106 may be formed by utilizing a third mask to perform a photolithography process and then performing an etching process. The X-direction electrode 1052, the Y-direction electrode 1051, and the electrode bridge layer 106 are formed simultaneously in the identical plane by using the third mask for photolithography process and further etching process. In one aspect of the present invention, the metal bridge pattern 102 can be the bridge between the X-direction electrode layer patterns for electrically connecting a plurality of X-direction electrode layer patterns. Similarly, the electrode bridge layer 106 can be the bridge between the Y-direction electrode layer patterns for electrical connecting a plurality of Y-direction electrode layer patterns. On the contrary, if the X-axis and the Y-axis interchange their direction, in another aspect of the present invention, the metal bridge pattern 102 may act as the bridge between the Y-direction electrode layer patterns for electrical connecting a plurality of Y-direction electrode layer patterns. The electrode bridge layer 106 may act as the bridge between the X-direction electrode layer patterns for electrically connecting a plurality of X-direction electrode layer patterns.

Referring to FIG. 2, it shows a representative plane view of a capacitive touch panel structure of the present invention. The FIG. 1 shows a cross-sectional view of the FIG. 2 along the A-A′ line cut. In one aspect of the present invention, the A-A′ direction may be designed as X-axis while B-B′ direction be designed as Y-axis. The X-direction electrode layer 1052 patterns are electrically connected by the metal bridge patterns 102 and the Y-direction electrode layer 1051 patterns are electrically connected by the electrode bridge layer 106. There is an electrode pattern spacing “a” set between adjacent X-direction layer patterns 1052 and adjacent Y-direction layer patterns 1051. In one aspect of the present invention, the electrode pattern spacing may be 5 to 40 microns. The optimized spacing can be 15 microns. Referring to FIG. 3, it shows the cross-sectional view of the FIG. 2 along the B-B′ line cut. In the FIG. 3, the Y-direction electrode layer 1051 and the electrode bridge layer 106 are formed in the same plane; in addition, both of the Y-direction electrode layer 1051 and the electrode bridge layer 106 are formed on surface of the insulating layer 103.

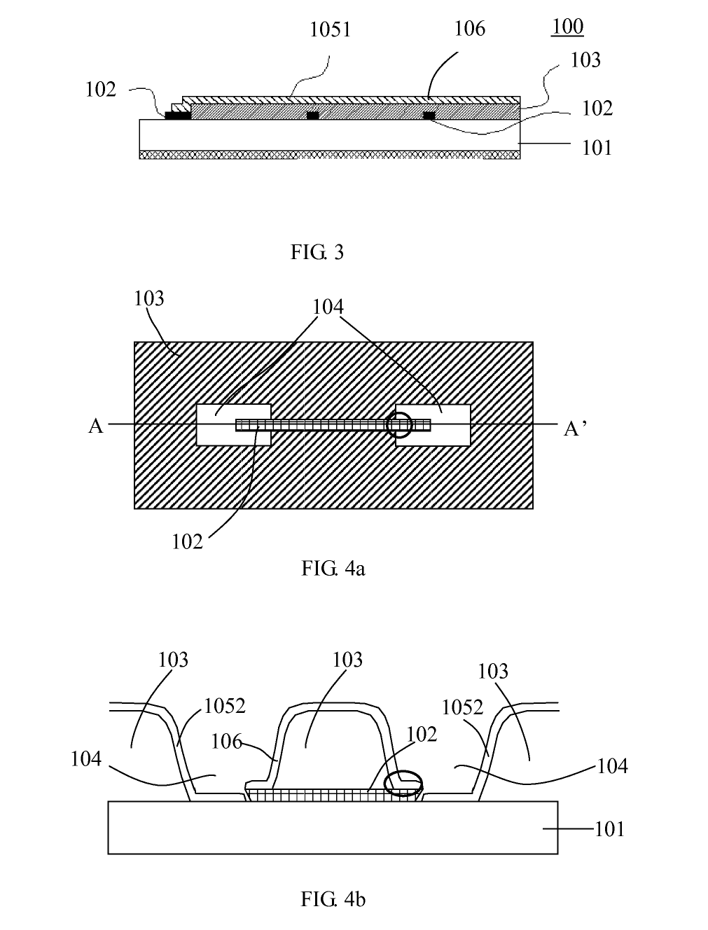

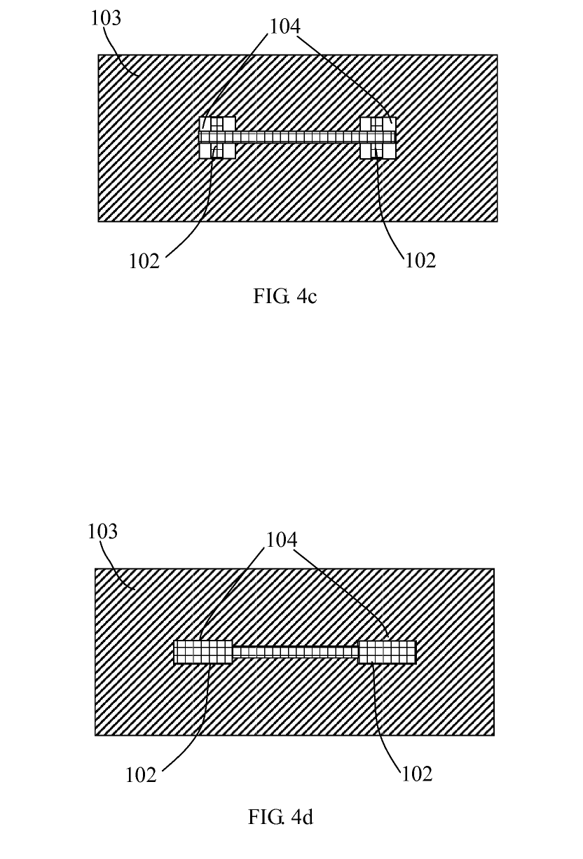

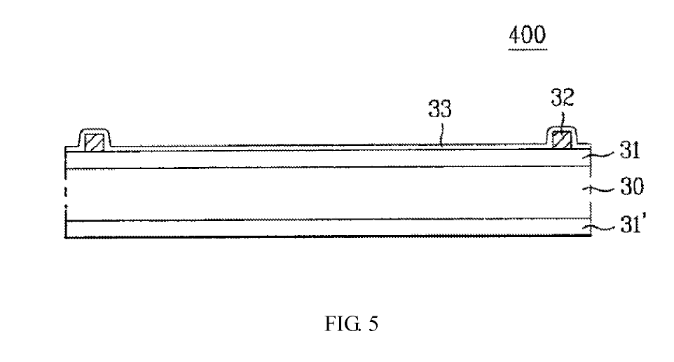

Referring to FIG. 4a and FIG. 4b, the edge of the metal bridge pattern 102 is easily to form an under-cut during the photolithography process by using the first mask and the etching process for forming the metal bridge pattern 102. To emphasize the point of view of the present invention, FIG. 4a doesn't show the transparent insulating layer 103. FIG. 4b is the cross-sectional view of the FIG. 4a along A-A′ line cut, and the FIG. 4a is a bottom view of the FIG. 4b. Therefore, as shown a “circle” in the FIG. 4a and FIG. 4b, after the deposition of the X-direction electrode 1052 and the electrode bridge layer 106, if the two ends of the metal bridge patterns 102 are not adjacent to the side wall of the via holes 104, due to the under-cut forming at the edge of the upper side of the metal bridge patterns 102, only part of the regions marked “circle” between the X-direction electrode layer 1052 and the metal bridge patterns 102 can electrically connect effectively. That results in the increasing of the total resistance. To overcome this issue, shrinking the size of the via holes 104 in the capacitive touch panel structure 100 of the present invention enables the side wall of the via holes 104 closely adjacent to the edge end of the metal bridge pattern 102, as shown in FIG. 4c. In addition, adding more metal bridge patterns on two ends of the original metal bridge pattern below the via holes 104, for example, increasing area that perpendicular to the original metal bridge pattern 102 enables formation of cross shape at the two ends of the metal bridge pattern 102. It should be noticed that the transparent insulating layer 103 is not shown in the FIG. 4c. The two ends of the perpendicular part of the metal bridge pattern 102 are also closely adjacent to the side wall of the via holes 104. Therefore, electrical conduction area between the metal bridge pattern 102 and the X-direction electrode layer 1052 can be increased, and thereby promoting the sensitivity.

In one aspect of the present invention, in FIG. 4d, the width of the two ends of the metal bridge pattern may be widened, and the size of the via holes 104 may be further reduced enabling the insulating layer 103 can only cover all the outer frame of the ends of the metal bridge patterns 102. It's noticed that the insulating layer 103 is not shown in the FIG. 4d. Therefore, the sub-sequential process of forming the X-direction electrode 1052 and the electrode bridge layer 106 will not suffer the under-cut issue. Then, the contact area between the metal bridge pattern 102 and the X-direction electrode can be maximized.

As described above, the present invention provides a capacitive touch panel and the Y-direction electrode layer 1051 are located in the same layer, any transmitting or reflecting light with identical angle will not result in any difference created by the optical sensing level. Due to the design of the present invention, the spacing between the electrode patterns is smaller than 15 microns. The spacing between those electrode patterns is beyond the resolution of human eyes. Users will not tell any non-uniformity from the electrode patterns. Even when users rotate the touch panel by an angle, there is no way to recognize the patterns of electrode. Therefore, the electrode patterns are still non-visual dependent. Further, in the present invention, the material for the bridge between the electrodes is made of metal, size of the via holes 104 of the capacitive touch panel structure 100 can be miniaturized. By partially increasing the metal bridge pattern 102 or increasing metal width, the contact area between the X-direction electrode 1052 and the metal bridge pattern 102 can be increased, and the resistance of the bridge section will be reduced. Therefore, sensitivity of the touch panel is increased and the contact problem caused by the under-cut of the metal bridge pattern edge can also be avoided. In one aspect of the present invention, the contact resistance may be reduced by 30% by utilizing the metal as the material of the bridge pattern of X-direction electrode layer.

In the present invention, the insulating layer 103 on the capacitive touch panel structure 100 is formed on the metal bridge pattern 102 and the substrate 101. This provides the capacitive touch panel structure 100 with a better transmission and reliability. In one aspect of the present invention, the fully covered insulating layer formed on the metal bridge in the capacitive touch panel structure also provides more uniform transmission comparing with the conventional island like insulating layer structure. By estimating, the transmission can improve by 3%. In the present invention, it only needs three masks for forming the capacitive touch panel structure 100 which are one electrode layer simplified compared with the conventional touch panel structure utilizing at least 4 masks, the manufacturing processes can be simplified and the cost can be reduced. Also a high temperature process in the following electrode layer manufacturing steps will be encountered. If the conventional island like insulating layer structure is utilized, a larger deformation per unit volume results from the high temperature process. The high degree deformation of the insulating layer induces cracks between the insulating layer and the electrode layer. The fully covered insulating layer can reduce the probability of deformation in the following high temperature process, therefore the formation of cracks between the insulating layer and the electrode layer can be avoided and the reliability can be increased.

Although preferred embodiments of the present invention have been described, it will be understood by those skilled in the art that the present invention should not be limited to the described preferred embodiments. Rather, various changes and modifications can be made within the spirit and scope of the present invention, as defined by the following Claims.

What is claimed is:

1. A capacitive touch panel structure, comprising:
a substrate;
metal bridge patterns formed on one surface of said substrate, wherein each said metal bridge patterns spaced apart in a predetermined distance;
an insulating layer fully covered on said surface of said substrate, between said metal bridge patterns, and on partial said metal bridge patterns, a plurality of via holes formed in said insulating layer and on said metal bridge patterns;
a first direction electrode layer and a second direction electrode layer, said second electrode layer formed on surface of said insulating layer and inside said via holes for electrical connecting with said metal bridge patterns; and
an electrode bridge layer for electrical connecting said first direction electrode layer, wherein said electrode bridge layer is formed on said surface of said insulating layer on said metal bridge patterns.

2. The capacitive touch panel structure of claim 1, wherein said first direction electrode layer and said second electrode layer are located at the same plane.

3. The capacitive touch panel structure of claim 1, wherein said first direction electrode layer and said electrode bridge layer are located at the same plane.

4. The capacitive touch panel structure of claim 1, wherein said second direction electrode layer and said electrode bridge layer are located at the same plane.

5. The capacitive touch panel structure of claim 1, wherein an electrode pattern spacing is formed between adjacent said first direction electrode pattern and said second direction electrode pattern.

6. The capacitive touch panel structure of claim 5, wherein said electrode pattern spacing is 5 to 40 microns.

7. The capacitive touch panel structure of claim 5, wherein said electrode pattern spacing is 15 microns.

8. The capacitive touch panel structure of claim 1, wherein a plurality of said metal bridge patterns have two ends, edges of said two ends closely adjacent to side walls of said via holes.

9. The capacitive touch panel structure of claim 8, wherein said two ends of said metal bridge pattern form cross shapes.

10. The capacitive touch panel structure of claim 1, wherein said metal bridge pattern includes two ends, size of said two ends approximately the same as the size of said via holes.

11. The capacitive touch panel structure of claim 1, wherein the material of said first direction electrode layer and said second direction electrode layer is indium-tin-oxide.

12. The capacitive touch panel structure of claim 1, wherein the material of said substrate is glass.

13. The capacitive touch panel structure of claim 1, wherein the material of said insulating layer is silicon dioxide base.

14. A capacitive touch panel, comprising:
a structure which comprises;
a substrate;
metal bridge patterns formed on one surface of said substrate, wherein each said metal bridge patterns spaced apart in a predetermined distance;
an insulating layer fully covered on said surface of said substrate, between said metal bridge patterns, and on partial said metal bridge patterns, a plurality of via holes formed in said insulating layer and on said metal bridge patterns;
a first direction electrode layer and a second direction electrode layer, said second electrode layer formed on surface of said insulating layer and inside said via holes for electrical connecting with said metal bridge patterns; and
an electrode bridge layer for electrical connecting said first direction electrode layer, wherein said electrode bridge layer is formed on said surface of said insulating layer on said metal bridge patterns.

15. The capacitive touch panel structure of claim 14, wherein said first direction electrode layer and said second electrode layer are located at the same plane.

16. The capacitive touch panel structure of claim 14, wherein said first direction electrode layer and said electrode bridge layer are located at the same plane.

17. The capacitive touch panel structure of claim 14, wherein said second direction electrode layer and said electrode bridge layer are located at the same plane.

18. The capacitive touch panel structure of claim 14, wherein an electrode pattern spacing is formed between adjacent said first direction electrode pattern and said second direction electrode pattern.

19. The capacitive touch panel structure of claim 18, wherein said electrode pattern spacing is 5 to 40 microns.

20. The capacitive touch panel structure of claim 18, wherein said electrode pattern spacing is 15 microns.

21. The capacitive touch panel structure of claim 14, wherein a plurality of said metal bridge patterns have two ends, edges of said two ends closely adjacent to side walls of said via holes.

22. The capacitive touch panel structure of claim 21, wherein said two ends of said metal bridge pattern form cross shapes.

23. The capacitive touch panel structure of claim 14, wherein said metal bridge pattern includes two ends, size of said two ends approximately the same as the size of said via holes.

24. The capacitive touch panel structure of claim 14, wherein the material of said first direction electrode layer and said second direction electrode layer is indium-tin-oxide.

25. The capacitive touch panel structure of claim 14, wherein the material of said substrate is glass.

26. The capacitive touch panel structure of claim 14, wherein the material of said insulating layer is silicon dioxide base.
